(19) United States
(12) Patent Application Publication
(10) Pub. No.: US 2013/0196047 A1
(43) Pub. Date: Aug. 1, 2013

(54) Process For The Production Of Fat-Containing Masses

(71) Applicants: Horst Zettl, Selb (DE); Dimitrios Makrakis, Hof (DE); Theron Harbs, Pomerode (BR); Michael Schmidt, Selb (DE)

(72) Inventors: Horst Zettl, Selb (DE); Dimitrios Makrakis, Hof (DE); Theron Harbs, Pomerode (BR); Michael Schmidt, Selb (DE)

(21) Appl. No.: 13/749,435

(22) Filed: Jan. 24, 2013

(30) Foreign Application Priority Data
Jan. 26, 2012 (DE) 10 2012 001 417.1

(51) Int. Cl. A23G 1/00

(52) U.S. Cl. CPC A23G 1/0016
USPC 426/631; 426/518; 426/658

(57) ABSTRACT

A process for the production of natural stimulants based on fat-containing masses. To produce the fat-containing mass, the raw materials are fed into an apparatus first. These raw materials are mixed in the apparatus and the required processing temperature and consistency are set. Then the mixed raw materials are liquefied in the apparatus by adding at least one fat and/or at least one oil. Finally, the fat-containing mass produced is pulverized through circulation between the apparatus and a grinding mill. The grinding mill may include two grinding zones. In the first grinding zone, the coarse components are pre-ground. In the subsequent main grinding zone, the pre-ground components are pulverized.

### FIELD OF THE INVENTION

The present invention relates to a process for the production of natural stimulants based on fat-containing masses.

### BACKGROUND OF THE INVENTION

Patent application WO 2005/077197 A1 discloses a process for manufacturing chocolate in which all raw materials such as e.g. cocoa nibs and crystal sugar undergo a pre-grinding process. Subsequently the ground raw materials are put into a U-shaped conche for further processing. Finally, the chocolate mass produced is pulverized by means of an agitator bead mill.

Conventional processes for the production of natural stimulants based on fat-containing masses, particularly processes for the production of chocolate, use a lot of energy and require a lot of space for the installation of the machines. Especially the processing of raw materials that are fed into the processing machines is very expensive and energy hungry in conventional processes.

### SUMMARY OF THE INVENTION

Therefore, it is the object of the present invention to provide a process for an efficient, energy- and resource-saving production of natural stimulants based on fat-containing masses.

The object according to the present invention is achieved by a process comprising the features of claims 1 and 2. Further advantageous embodiments are described in the features of the subclaims.

Another object of the present invention relates to a fat-containing mass produced according to the above-mentioned process.

This object is achieved by a fat-containing mass comprising the features of claim 18. Further advantageous embodiments are described in the features of the subclaims.

A process for the production of natural stimulants based on fat-containing masses is described. The first step in the production of the fat-containing mass is to feed the raw materials into an apparatus. Said raw materials are, among others, cocoa nibs, cocoa liquor, cocoa blocks or cocoa drops and crystal sugar. These raw materials are mixed directly in said apparatus without being pre-ground and the required processing temperature and consistency are set. The next step is to liquefy the mixed raw materials in said apparatus by adding at least one fat and/or at least one oil. As a final step, the fat-containing mass produced is pulverized through circulation between said apparatus and a grinding mill. In a preferred embodiment, said grinding mill comprises two grinding zones. In the first grinding zone, the coarse components are pre-ground, in the subsequent main grinding zone, the pre-ground components are pulverized.

More particularly, a second process refers to the production of chocolate, which is also a natural stimulant based on fat-containing masses. The first step in the production of chocolate is to feed the raw materials into an apparatus. These raw materials are mixed in said apparatus and the required processing temperature and consistency are set. As an intermediate step, the raw materials undergo a dry conching treatment in said apparatus. As a result of this intermediate step, which may take several hours, undesirable components such as e.g. undesirable flavors are removed from the fat-containing raw mass. This is generally referred to as neutralization of the fat-containing raw mass. The process of conching is sufficiently known in chocolate manufacturing and is therefore not described in detail herein. However, the use of this intermediate step in said apparatus prior to liquefaction is new and considerably improves the energy efficiency of said apparatus and the efficiency of said process. Subsequently, the mixed raw materials are liquefied in said apparatus by adding at least one fat and/or at least one oil. Finally, the fat-containing mass produced is pulverized through circulation between said apparatus and a grinding mill.

After the liquefaction of the mixed raw materials, one or several additives are added to the fat-containing mass. These additives can be, for example, nuts, broken cookies and the like. These additives determine the specific flavor or the specific consistency. The process according to the present invention allows to add these additives prior to, during or after the pulverization.

The fat-containing mass is ground in said grinding mill in two steps. First, the fat-containing mass flows through a pre-grinding zone of said grinding mill and subsequently, it is finely ground in the main grinding zone of said grinding mill. A separate machine can be used each for pre-grinding and for fine-grinding, with both machines being arranged after said apparatus. It is, however, also possible to carry out both grinding procedures in one machine, as described above for the preferred embodiment.

The air required in the process according to the present invention for removing undesirable flavors and for tempering the fat-containing mass is introduced into the fat-containing mass through a mixing shaft. In addition to the removal of undesirable flavors, a neutralization of the fat-containing mass takes place. Tempering of the fat-containing mass, especially of cocoa mass, is performed according to a specified temperature curve. As a result of this specific temperature sequence, beta V crystals are formed in the fat-containing mass, more particularly in the cocoa butter. These beta V crystals represent a dense cocoa butter crystal structure and prevent the migration of foreign fats. The discharge of exhaust air from the apparatus is accelerated by suction.

The fat-containing mass is circulated between said apparatus and said grinding mill by means of a pump. This circulation process is continued until the fat-containing mass or, more specifically, the chocolate has reached the desired fineness. Moreover, it is possible to temper the fat-containing mass during pumping. This tempering can be either heating or cooling. Heating serves to keep the fat-containing mass or the chocolate fluid. Cooling, however, shall prevent the fat-containing mass or the chocolate from scorching or from changing its flavor.

In said grinding mill, grinding agents made of steel and/or ceramic are used. After said grinding mill, a component is arranged by means of which any broken and/or rubbed off parts from said grinding agents made of steel and/or ceramic are removed from the production cycle. In a preferred embodiment, an agitator bead mill is used as a grinding mill. Furthermore, a conche is used as an apparatus. Said apparatus and said grinding mill are lined with steel or with a ceramic material. A positive displacement pump, preferably a progressing cavity pump, is used as a pump. This pump can be tempered, as already mentioned above.

Furthermore, a fat-containing mass is disclosed which is produced according to the process of the present invention. Said fat-containing mass is a compound, a filling, a coating or chocolate. Said fat-containing mass may contain additives such as nuts or broken cookies. These additives are contained in the finished fat-containing mass in whole form, as broken pieces or in finely ground form.

Hereinafter, the invention and its advantages are described in more detail by means of the embodiments shown in the figures annexed hereto. The proportions of the individual elements in the corresponding figures in relation to each other do not always correspond to the real proportions as some forms are simplified and other forms are enlarged in relation to other shown elements for better illustration.

### BRIEF DESCRIPTION OF THE DRAWINGS

FIG. 1 illustrates a process according to the present invention for the production of a fat-containing mass/chocolate.

FIG. 2 illustrates an apparatus for use in the process according to the present invention.

FIG. 3 illustrates a grinding mill with two grinding zones.

### DETAILED DESCRIPTION OF THE INVENTION

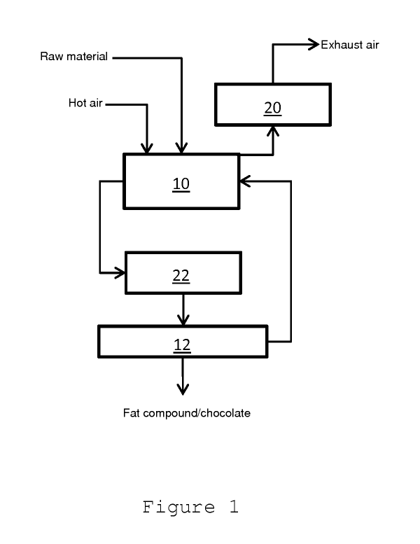

FIG. 1 illustrates a process according to the present invention for the production of a fat-containing mass/chocolate. To produce said fat-containing mass, the raw materials are fed into an apparatus 10 first. These raw materials are mixed in said apparatus 10 and the required processing temperature and consistency are set. Then the mixed raw materials are liquefied in said apparatus 10 by adding fats and/or oils. Finally, the fat-containing mass produced is pulverized through circulation between said apparatus 10 and a grinding mill 12. A pump 22 is used for the circulation process. The exhaust air is discharged through a suction 20 in an accelerated way.

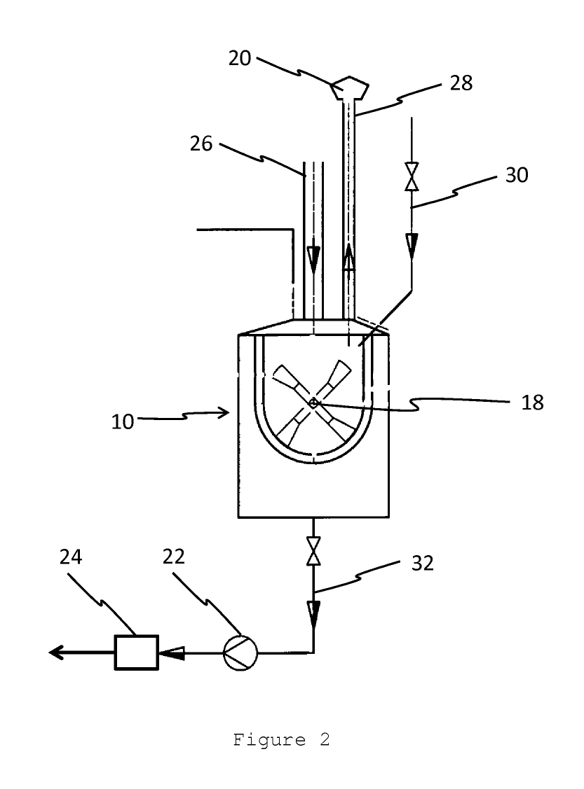

FIG. 2 illustrates an apparatus 10 for use in the process according to the present invention. In said apparatus 10, the raw materials are fed through the raw material inlet 26. The warm air required in said process is introduced directly into the fat-containing mass in said apparatus 10 through the mixing shaft 18. The exhaust air with all the undesirable gaseous constituents is removed from said apparatus 10 through the exhaust duct 28 and the downstream suction 20. Prior to withdrawing the fat-containing mass from said apparatus 10, the fat-containing mass is liquefied by adding fat and/or oil via the fat/oil feeding 30. When the required consistency has been set, the fat-containing mass is pumped off through the outlet 32 by means of the pump 22 and subjected to further processing. After said pump 22, a component 24 is arranged by means of which broken or rubbed off steel and/or ceramic parts can be removed from said apparatus 10 and/or from said grinding mill (not represented) from the finished fat-containing mass.

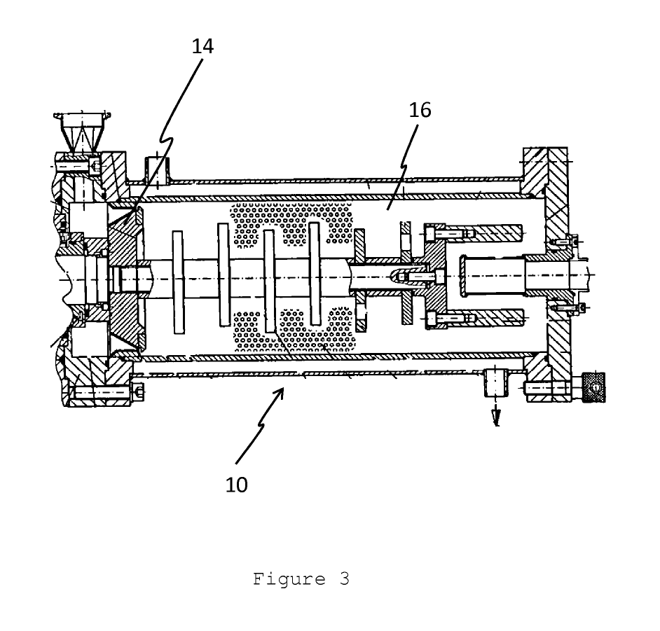

FIG. 3 illustrates a grinding mill 12 comprising two grinding zones 14 and 16. In the illustrated embodiment, said grinding mill 12 is an agitator bead mill. Said grinding mill 12 comprises two grinding zones 14 and 16. In said pre-grinding zone 14, the coarse components contained in the fat-containing mass are ground using a special system. The pre-ground fat-containing mass then flows into said main grinding zone 16 where it is finely ground to reach the desired final fineness. An agitator bead mill of this kind is known from German Patent Application DE 10 2008 058 585 A1.

The invention was described with reference to a preferred embodiment.

1. A process for the production of natural stimulants based on fat-containing masses, characterized by the following steps:
a. feeding the raw materials into an apparatus;
b. mixing the raw materials in said apparatus as well as setting the required processing temperature and consistency;
c. liquefying the mixed raw materials in said apparatus by adding at least one fat and/or at least one oil;
d. fine-grinding the fat-containing mass produced through circulation between said apparatus and a grinding mill.

2. A process for the production of natural stimulants based on fat-containing masses, preferably chocolate, characterized by the following steps:
a. feeding the raw materials into an apparatus;
b. mixing the raw materials in said apparatus as well as setting the required processing temperature and consistency;
c. dry-conching the raw materials in said apparatus;
d. liquefying the mixed raw materials in said apparatus by adding at least one fat and/or at least one oil;
e. fine-grinding the fat-containing mass produced through circulation between said apparatus and a grinding mill.

3. The process according to claim 1, characterized in that after the liquefaction of the mixed raw materials one or several additives are added.

4. The process according to claim 1, characterized in that said fat-containing mass is ground in said grinding mill in two steps.

5. The process according to claim 4, characterized in that said fat-containing mass first flows through a pre-grinding zone of said grinding mill and is then finely ground in the main grinding zone of said grinding mill.

6. The process according to claim 1, characterized in that a separate machine is used each for pre-grinding and for fine-grinding, with both machines being arranged after said apparatus.

7. The process according to claim 1, characterized in that the air required in said process is introduced into the fat-containing mass through a mixing shaft.

8. The process according to claim 1, characterized in that the exhaust air is discharged from said apparatus through a suction in an accelerated way.

9. The process according to claim 1, characterized in that the fat-containing mass is circulated between said apparatus and said grinding mill by means of a pump.

10. The process according to claim 9, characterized in that by means of said pump the fat-containing mass is tempered during pumping.

11. The process according to claim 1, characterized in that grinding agents made of steel and/or ceramic are used in said grinding mill.

12. The process according to claim 11, characterized in that after said grinding mill a component is arranged by means of which any broken and/or rubbed-off parts from said grinding agents made of steel and/or ceramic are removed from the production cycle.

13. The process according to claim 1, characterized in that an agitator bead mill is used as a grinding mill.

14. The process according to claim 1, characterized in that a conche is used as an apparatus.

15. The process according to claim 13, characterized in that said apparatus and said grinding mill are lined with steel or with a ceramic material.

16. The process according to claim 1, characterized in that a positive displacement pump, preferably a progressing cavity pump, is used as a pump.

17. The process according to claim 16, characterized in that said pump can be tempered.

18. A fat-containing mass produced according to the process according to claim 1, characterized in that said fat-containing mass is a compound, a filling, a coating or chocolate.

19. The fat-containing masses according to claim 18, characterized in that said fat-containing mass contains additives such as nuts or broken cookies.

20. The fat-containing mass according to claim 19, characterized in that said additives are contained in said fat-containing mass in whole form, as broken pieces or in finely ground form.
